(19) United States
(12) Patent Application Publication
(10) Pub. No.: US 2002/0144127 A1
(43) Pub. Date: Oct. 3, 2002

(54) Apparatus, system and method for personal identification

(76) Inventors: Hirofumi Miyata, Kyoto (JP); Hiroyuki Iwao, Kyoto (JP); Takeshi Miyamoto, Kyoto (JP)

Correspondence Address: DICKSTEIN SHAPIRO MORIN & OSHINSKY LLP, 2101 L STREET NW, WASHINGTON, DC, 20037-1526, US

(21) Appl. No.: 10/105,245

(22) Filed: Mar. 26, 2002

(30) Foreign Application Priority Data
Mar. 28, 2001 (JP) 2001-91790

(51) Int. Cl. H04K 1/00; H04L 9/00

(52) U.S. Cl. 713/185

(57) ABSTRACT

The purpose of the invention is to provide an apparatus, system and method for personal identification with an improved capability of generating registration data in which biometrics information of a person to be identified can be acquired and accumulated each time identification is used at an operation such as unlocking of a door only by registering ID information and so on with no biometrics information of the person to be identified registered in advance and in which registered data of the person can be efficiently generated based on the log data thus accumulated. The invention is characterized in that a person is identified from biometrics information by providing an input unit for inputting the identification information, an acquisition unit for acquiring biometrics information of the person to be identified and a storage unit to which the identification information is input from the input unit and in which the identification information and the biometrics information is stored in association with each other when the biometrics information is acquired by the acquisition unit.

### BACKGROUND OF THE INVENTION

1. Field of the Invention

The present invention relates to a personal identification apparatus for identifying and checking biometrics information specific to a person and, more particularly, to a personal identification apparatus, a personal identification system and a method for personal identification in which registration and setting of registered personal information to serve as a database for personal identification is simplified to improve the performance of registration.

2. Description of the Related Art

In general, a personal identification apparatus and an identification system thereof utilizing biometrics information (biometrics data) that is different from person to person for checking the face, fingerprint or voice print of a person are installed in various apparatus as authentication units for verifying a person to be identified to achieve security control.

Such identification systems utilizing biometrics information are categorized into two types, i.e., a verification type and an identification type. A verification type system checks an input ID against stored biometrics information, and an identification type system checks a person by finding data having the highest match rate without using an ID. Therefore, it is known that a person is only required to press a button to be identified in the case of an identification type system.

When such a personal identification apparatus is operated, biometrics information specific to human beings must be registered in advance as a database for personal identification. To register biometrics information in advance, people to be registered are invited to a place for acquiring information to be registered to perform a registration process for each individual.

In this case, however, registering operations are required for all people to be registered, and the people to be registered must visit a designated place at a designated time to perform the registering operations. Thus, it has been time-consuming and troublesome to create a database for both the registration manager and the people to be registered. Especially, an increase in the scale of an identification system increases registering operations enormously, which has resulted in a problem in that too much man-power is required.

Under such circumstances, the invention provides a personal identification apparatus, a personal identification system and a method of personal identification in which biometrics information of people to be identified can be acquired and accumulated each time identification is used, e.g., at each operation of unlocking a door only by registering ID information or the like in advance without registering the biometrics information of the people to be identified and in which registration data of the people can be efficiently generated based on the log data thus accumulated.

### SUMMARY OF THE INVENTION

The invention is characterized in that a person is identified by providing an input unit for inputting identification information for identifying the person to be identified, an acquisition unit for acquiring biometrics information of the person to be identified, and a storage unit to which the identification information is input from the input unit and in which the identification information and the biometrics information is stored in association with each other when the biometrics information is acquired by the acquisition unit.

As a result, biometrics information and identification information of a person to be identified is collected in association with each other each time the person to be identified performs a control operation such as unlocking of a door by storing the identification information of the person to be identified in advance in the storage unit and by inputting the identification information such as an ID using the input unit such as ten keys; a preliminary operation period is provided in which a preliminary personal dictionary is created using the identification information and biometrics information at that time as log data; and an official personal dictionary can be created by associating the identification information and biometrics information of each person using the identification information as a key for identification after the preliminary operation period.

Therefore, a registration manager can be freed from an operation of registering biometrics information in advance in which a registering operation is required to be performed for each of people to be registered in advance. This makes it possible to save time and labor required for both of the people to be registered and the registration manager to perform the pre-registration and to generate personal registration data at natural attitudes and identification timing of the people to be registered that are encountered in daily use of such an apparatus, which ensures improvement of recognition performance at the time of identification.

Further, since the registration manager can see the state of use of a person at the time of registration during the preliminary operation from an image, the manager can appropriately advise the person to be identified of a proper way of use when there is any problem.

For example, an ID number may be an employee number or a dedicated number assigned for identification. An employee number is advantageous in that it is easy to input because it is a number familiar to the person. A dedicated number is advantageous in that the number of the digits of the ID can be smaller than that of a normal employee number.

Referring to operations, a preliminary operation may be performed in which no identification based on identification information is carried out and, in this connection, there are three patterns of preliminary operation.

(1) Passage of a person is allowed with an image acquired on the person without judging whether an ID has been registered or not. Security is low in this case because no identification is carried out using an ID, although the person is required to input an ID.

(2) It is judged whether an ID has been registered for a person or not and, if yes, the person is allowed to pass with an image acquired on the person. If not, the person is not allowed to pass, and an image of the person is taken as a log. No password is used, and security is at the medium level.

(3) When an ID and a password are checked, security can be improved to achieve high security.

Thus, since preliminary registration data can be generated even if no biometrics information has been acquired at the time of initial registration of people to be registered, the performance of identification and management of unregistered people can be improved. It is therefore possible to construct an identification system with improved automatic registration having an efficient registration capability requiring less time and labor in applications to various recognition apparatus and systems.

A preliminary operation period may be provided when a database is newly constructed, and it may alternatively be provided for a person who is added during an actual operation.

Identification information is data for identifying a person to be identified such as the name, the position of the person in an organization, the contact and the ID number. It is information that can be registered by a registration manager instead of the person in advance.

The input unit may be constituted by an input device such as secret code keys or touch panel.

A face image acquisition unit, fingerprint acquisition unit or voice print acquisition unit may be used as the acquisition unit.

Biometrics information is information on the face of a person to be identified, and it is also possible to use information specific to the person such as fingerprint information and voice print information that allows the person to be identified.

### BRIEF DESCRIPTION OF THE DRAWINGS

FIG. 1 is a front view of a face image identification apparatus;

FIG. 2 is a block diagram of a control circuit of a face image identification system;

FIG. 3 illustrates a control operation of a center apparatus;

FIGS. 4A and 4B illustrate contents of data required in an actual operation;

FIG. 5 illustrates identification information and log information during a preliminary operation;

FIG. 6 illustrates pre-registration data with a preliminary ID set therein;

FIG. 7 illustrates identification information and log information with a preliminary ID set therein;

FIG. 8 is a flow chart showing processes and operations for generating personal dictionary data;

FIG. 9 is a flow chart showing processes and operations in a preliminary operation period of the face image identification apparatus;

FIG. 10 is a flow chart showing processes and operations utilizing a preliminary ID in the preliminary operation period of the face image identification apparatus; and

FIG. 11 is an external perspective view of a major part of a fingerprint identification apparatus representing another embodiment of the invention.

### DESCRIPTION OF THE PREFERRED EMBODIMENTS

A preferred embodiment of the invention will now be described with reference to the drawings.

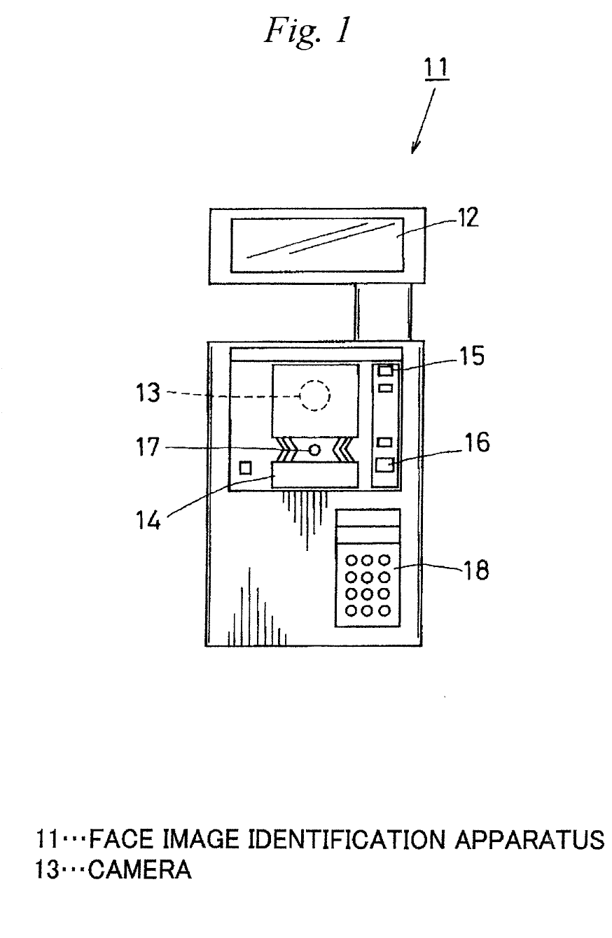

FIG. 1 shows a face image identification apparatus provided at an image acquisition end of a face image identification system for identifying people by photographing the faces. In FIG. 1, a face image identification apparatus 11 is provided as a unit for identifying people to be identified to manage opening and closing of a door used for entering and exiting a room, for example. The apparatus has a function of acquiring identification data and a function of acquiring authentication data and is mounted in a position on a surface of the door at the height of the faces of the people. It has an illuminator 12 for illuminating the faces in an upper part thereof, a camera 13, a man-detecting sensor 14, identification result display LED's 15, an identification start button 16 and an fixation mark 17 in an intermediate part thereof and secret code keys (ten keys) 18 in a lower part thereof.

A plurality of illuminating LED's are arranged as the illuminator 12 to illuminate a position at the height of faces in front thereof. This makes it possible to clearly illuminate irregularities of the face of a person who has approached the camera 13, thereby improving face image acquiring performance of the camera 13.

A CCD camera or the like is used as the camera 13 to photograph face images. When a person approaches the camera 13 in front thereof, the man-detecting sensor 14 which may be a reflection type infrared sensor detects that a person has approached. When the identification start button 16 is then pressed, the camera 13 starts photographing based on a judgment that there is a request for identification of a person to be identified, and identification is started based on an image thus acquired. At this time, the result of identification indicating whether there is a match for the person under identification or not is output to be displayed by the identification result display LED's 15. On the identification result display LED's 15, either of two LED's in different colors is turned on to indicate the result of judgement in blue or red, thereby allowing the result of identification to be recognized at a glance.

When identification as described above is used, the secret keys 18 may be used in substitution for or in combination with the identification start button 16 to perform authentication.

Identification data thus acquired is introduced to a center apparatus 21 to be described later provided at an authenticating and monitoring end through a connection cable or on a wireless basis to judge the identification data is adequate or not.

The apparatus 21 may be provided in the vicinity of the face image identification apparatus 11 and configured as a control unit for the face image identification apparatus 11 instead of being provided as a center apparatus. A plurality of the face image identification apparatus 11 may be connected to the center apparatus 21.

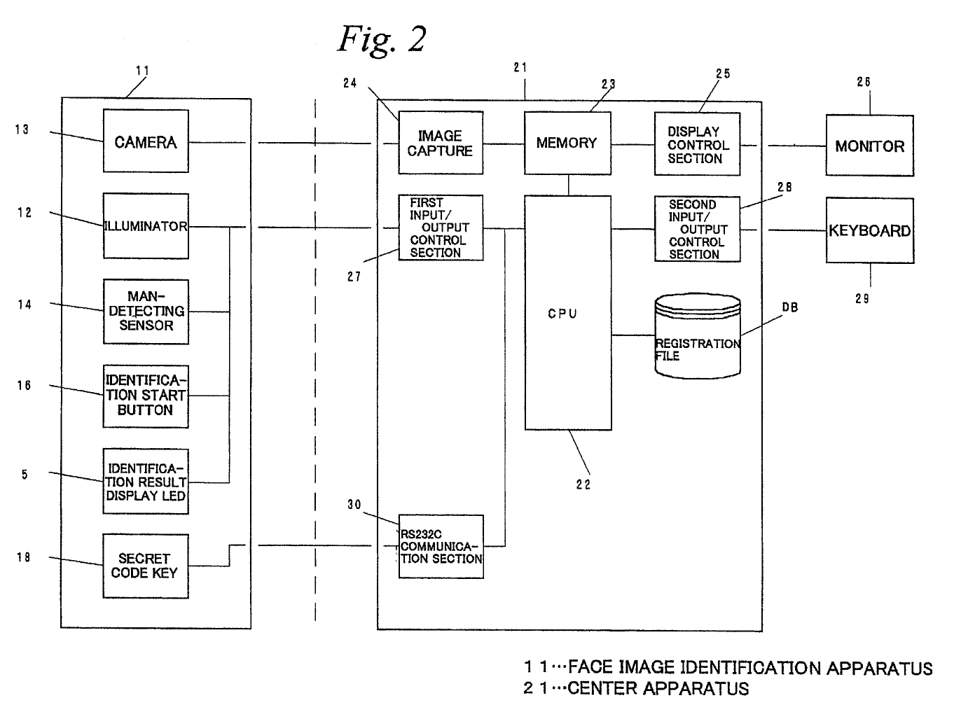

FIG. 2 shows a block diagram of a control circuit of the face image identification system that is controlled and managed by the center apparatus 21 which controls each of the units provided in the face image identification apparatus 11.

A CPU 22 of the center apparatus 21 controls each circuit device according to processing steps of a program stored therein and stores resultant control data in a memory 23.

An image capturer 24 acquires an image photographed by the camera 13 and stores it in the memory 23. The acquired image is displayed on a monitor 26 for monitoring through a display control section 25.

A first input/output control section 27 controls input and output data of each of the illuminator 12, the man-detecting sensor 14, the identification result display LED's 15 and the identification start button 16 provided in the face image identification apparatus 11, and a second input/output control section 28 controls input from a keyboard 29 for monitoring authentication.

An RS232C communication section 30 has a communication interface function for transmitting input data from the secret code keys 18 to the CPU 22.

A registration file DB is provided as a database file when a face image is registered, and data of characteristic quantities of a face image of each person to be registered is stored in the same.

The CPU 22 checks face image information of a person to be identified photographed with the camera 13 against information that has been registered in advance and allows or disallows the person to enter or exit a room based on the result of identification.

A process of updating registration data set for each person to be identified will now be described.

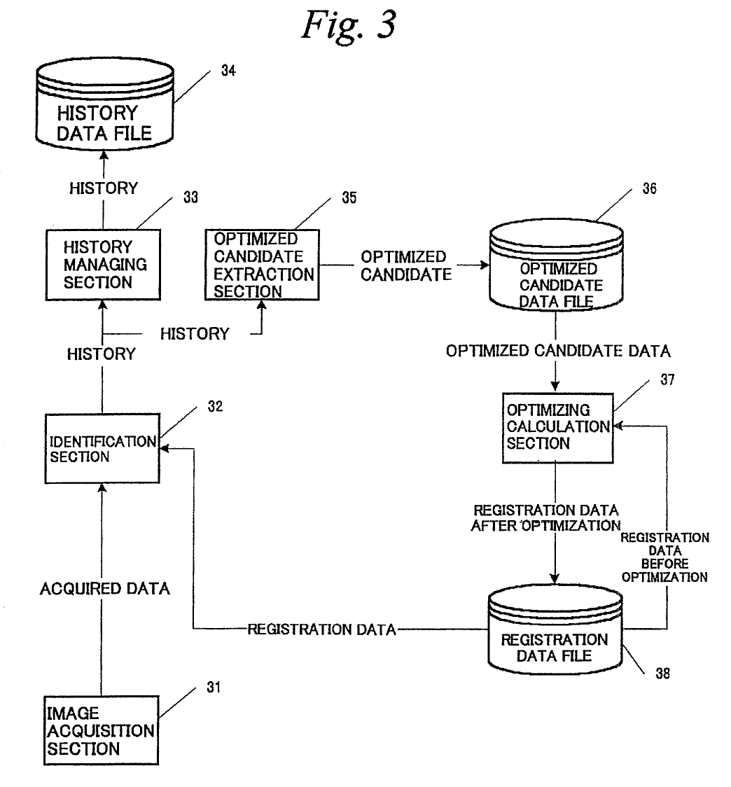

FIG. 3 shows a data processing operation of the center apparatus 21 in which an image is first acquired with an image acquisition section 31. The face image (acquired data) fetched into the image acquisition section 31 is checked by an identification section 32 against registration data recorded in a registration data file 38 in advance {ID of the registered person+(face image+characteristic quantities)×n}. The result of authentication and historical data of the image is managed by a history managing section 33, and one log of historical data (the date and time of acquisition+face image+characteristic quantities+ID for the result of identification) is finally stored in a historical data file 34.

At each access for identification, optimized candidate data for data updating is extracted from the resultant historical data by an optimized candidate extraction section 35 and is stored in an optimized candidate data file 36 each time.

Thereafter, when an update of a registered person is due or requested or when there is a request for preliminary registration of an unregistered person, an optimizing calculation section 37 obtains optimized candidate data {the personal ID+(face image+characteristic quantities) ×m} from the optimized candidate data file 36 and reads out the registration data stored in the registration data file 38. It chooses the item of data having the higher priority as new registration data and registers the new registration data thus obtained in the registration data file 38 as registration data newly generated after the optimization.

Thus, data acquired at access for identification is accumulated in the optimized candidate data file 36, and new registration data is generated from optimized candidate data and the registered data only at the time of data updating or preliminary registration and is registered in the registration data file 38.

Referring to the operation of registering a person to be identified, the registration manager makes arbitrary setting for registration based on historical data that is obtained at the time of daily access when the face image identification apparatus 11 is used. Since this eliminates a need for performing a registering operation for each unidentified person, registration management can be efficiently performed.

Specifically, to generate the registration data, identification information of a person to be identified is stored (in the registration file DB in FIG. 2 and in the registration data file 38 in FIG. 3). Each time the person to be identified performs a control operation such as unlocking of a door by inputting the identification information such as an ID with the input unit such as the secret code keys 18, biometric information of the person to be identified is collected in association with the identification information. A preliminary operation period is provided to create a preliminary personal dictionary using the identification information and the biometrics information at that time as log data. An official personal dictionary is created by associating the identification information and biometrics information of each person using the identification information as a key for identification after the preliminary operation period. It is therefore possible to omit a pre-registration operation that is an operation performed by a registration manager for all people to be registered to register biometrics information of each of the people in advance.

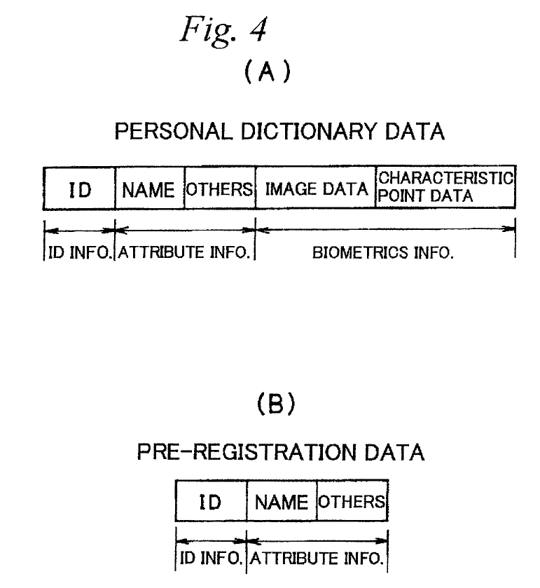

A description will now be made with reference to FIGS. 4A and 4B on the contents of each item of data required for generating registration data for each person to be identified.

FIG. 4A shows personal dictionary data that is recorded as a database required for registering each person. ID information for identifying the person to be identified, attribute information and biometrics information is registered as the personal dictionary data.

The ID information is information that is assigned an ID number for identifying the person and that is registered along with other data for identification using the ID information as a reference. As the attribute information, other pieces of information associated with the person are registered including the name of the person, the person's position in an organization, the sex, the year, month and date of birth and the contact.

In this case, the ID information and attribute information is pre-registration data (identification information) which can be input and registered by a registration manager in advance, as shown in FIG. 4B. For example, the registration manager determines people to be registered in advance and registers the ID information of each of the people to be registered along with the attribute information. The attribute information may be registered when the ID information is associated with biometrics information to be described later or after such association is carried out.

Referring to the biometrics information, data of an image of the face of a person photographed with the camera 13 of the face image identification apparatus 11, data of characteristic points which are obtained as a set of unique points as a result of an analysis of the photographed image data, and raw image data actually acquired from the person are registered. Either of the image data and the characteristic point data may be used alone as the biometrics data. Alternatively, both of the data may be used.

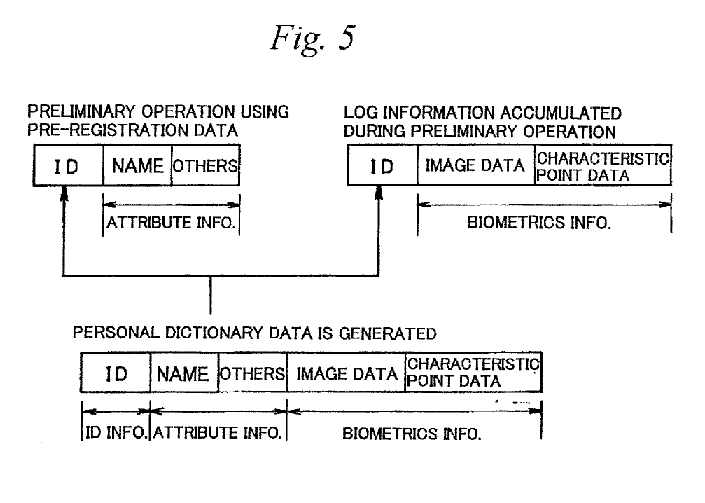

To generate personal dictionary data, as shown in FIG. 5, a preliminary operation intended for unregistered people is performed using pre-registration data registered in advance excluding biometrics information. During the preliminary operation, preliminary operation data is accumulated by associating ID information included in the pre-registration data with biometrics information photographed with the camera 13, and the registration manager creates personal dictionary data by associating the accumulated preliminary operation data with the ID information.

A description will now be made on an example of extraction in which face image data that can be used for registration is extracted from image data acquired with the camera 13.

First, it is checked using the acquired image data whether the ID information matches the person to be identified. If yes, the registration manager checks the acquired face image data to extract biometrics information. For example, the registration manager observes the face image data and extracts biometrics information that seems to serve identification by checking:

(1) whether the person's eyes are closed or not;

(2) whether the person faces forward or not;

(3) whether the image is blurred or not;

(4) whether the entire face is shown or not; and

(5) whether the face image is too small or not.

Thus, registration data can be generated even for a person whose biometrics information has not been registered yet. By identifying and confirming the person through the input of the ID information when the person uses the identification apparatus, biometric information acquired at that time can be added to generate new registration data of the person.

In this case, since the registration manager can see the state of use of the person to be identified in progress, an appropriate way of use can be advised to the person to be identified when there is any problem in the state of use.

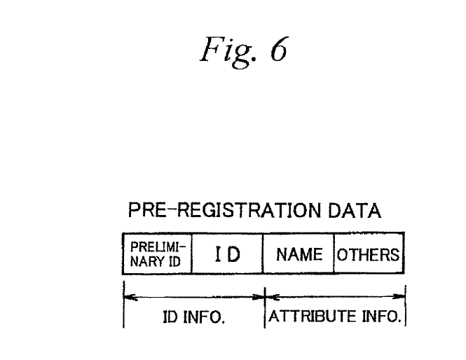

The ID information is not limited to the ID information shown in FIGS. 4A and 4B, and a preliminary ID may be set as shown in FIG. 6. Referring to the preliminary ID, for example, certain preliminary ID's are input to increase the identifying capacity or used when some people to be identified have no real ID or the people have forgotten the real ID numbers.

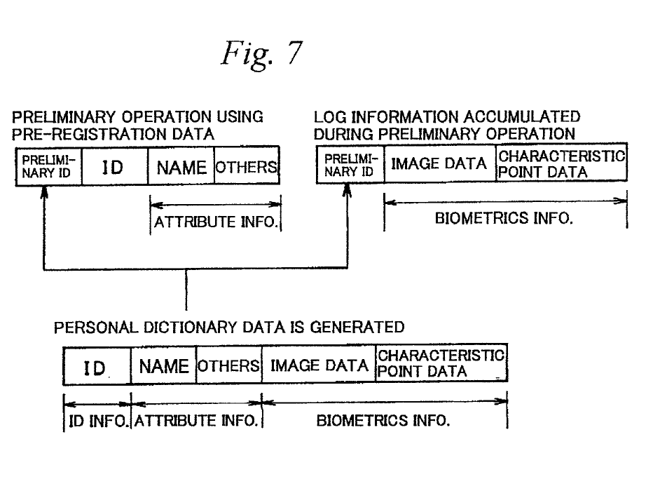

In this case, since the people can be immediately associated with the preliminary ID's as shown in FIG. 7, personal dictionary data can be generated by recording biometrics information in association with the preliminary ID information of each of the people to be registered.

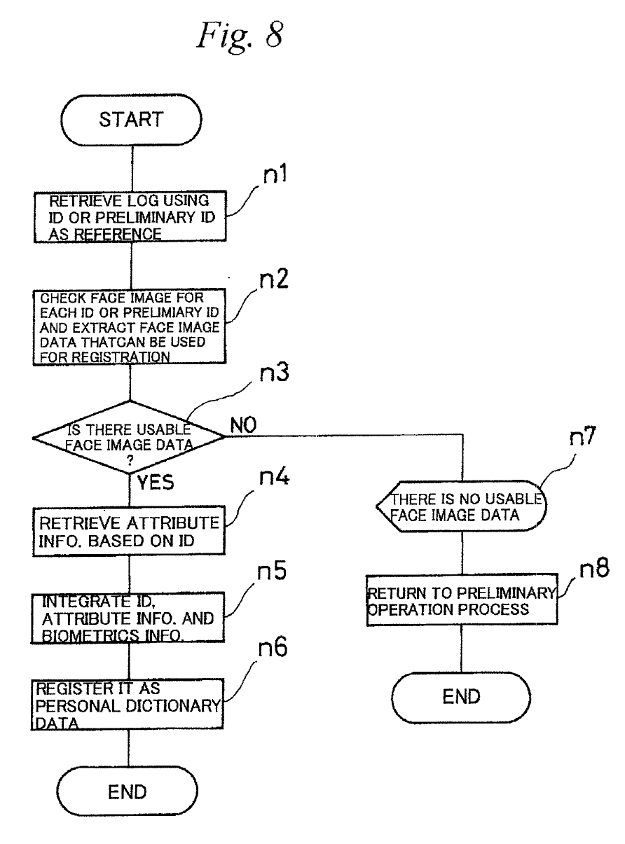

Processes and operations for generating personal dictionary data will now be described with reference to the flow chart in FIG. 8.

When a registration manager generates personal data, all face images associated with an ID or preliminary ID from are retrieved from log data recorded until that time based on information on the ID or preliminary ID (step n1), and the registration manager extracts face image data that can be used for registration from them (step n2).

At this time, it is checked whether there is face image data that can be used for registration. When there is face image data that can be used for registration (step n3), attribute information associated with the ID information is then retrieved (step n4); the retrieved ID information and attribute information is associated with biometrics information to be integrated therewith (step n5); and the integrated personal data is registered as personal dictionary data. Thus, the registration manager generates registration data of an unregistered person, and the generated registration data is used as a database for identification thereafter (step n6).

When is found at step n3 that no ID information has been recorded or there is no face image data that can be used for registration, registration cannot be carried out. Therefore, the process returns to the preliminary operation process after the registration manager is so informed (steps n7 and n8).

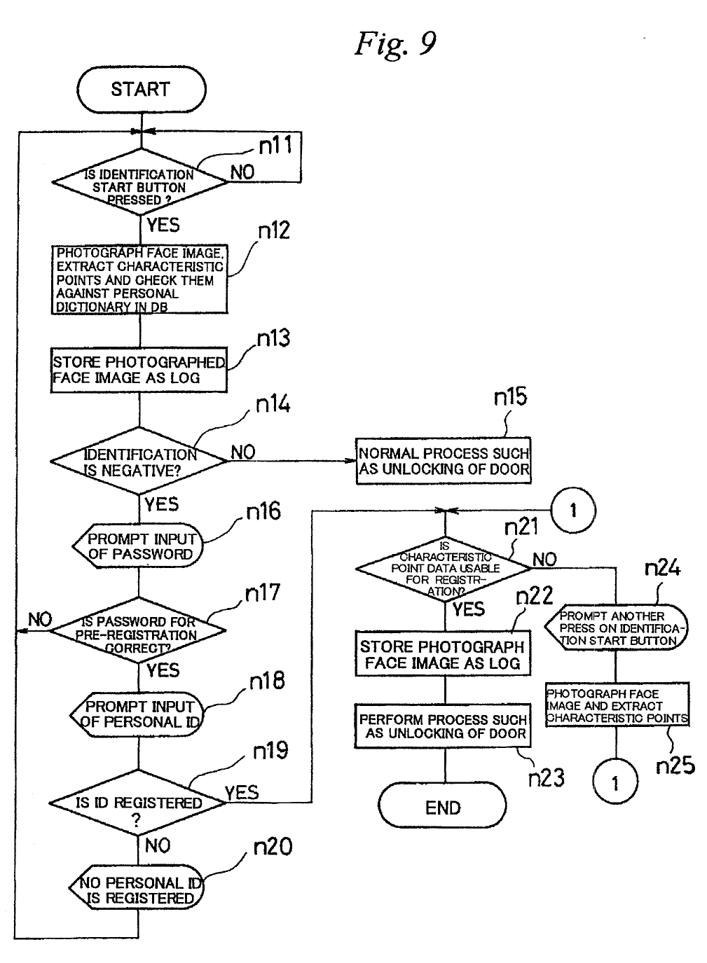

Processes and operations during the preliminary operation of the face image identification apparatus 11 will now be described with reference to the flow chart in FIG. 9.

When a person comes in front of the face image identification apparatus 11 and presses the identification start button 16 (step n11), the CPU 22 acquires images of the face of the person to be identified immediately after the press on the identification start button 16 with the camera 13. Based on the acquired face image data, the CPU 22 scans the position of the face to slice parts having high likelihood of being the face, extracts characteristic quantities of the face such as the eyes, nose and mouth to serve as characteristics for identification, and performs a process of recognizing the person to be identified by checking such biometrics information against personal dictionary data registered in advance (step n12).

At this time, an image of the person to be identified suitable for identification is extracted from among the plurality of acquired images and is recorded in the optimized candidate data file 36 (step n13).

In this case, the CPU 22 judges whether the identification results in a match. If the identification results in a match to allow the person to be identified (step n14), it judges that recognition was successfully performed to determine a right person and performs normal processes such as unlocking of a door to allow the person to be identified to pass (step n15).

On the contrary, when it is judged that the identification results in no match, since the person cannot be identified, the person to be identified is prompted to input a password in order to keep security (step n16).

When a password is input, it is judged whether the password is correct or not (step n17).

When it is judged that the password is correct, the person is prompted to input ID information (step n18).

When ID information is input, the CPU 22 judges whether the ID information is correct or not (step n19).

If no ID information is input or if the ID information is judged to be incorrect at this time, the person to be identified is so notified (step n20).

When the CPU 22 confirms that the correct ID information has been input at the step n19, it subsequently judges whether characteristic point data of the acquired image has quality usable for registration (step n21).

When it is determined that the data has adequate quality suitable for registration, the person is identified and confirmed; the acquired image data is recorded in the optimized candidate data file 36 as log data (step n22); and normal processes such as unlocking the door are performed to allow the person to be identified to pass (step n23).

On the contrary, when the quality of the characteristic point data of the acquired image is judged to be unusable image quality as a result of the judgment on whether it has quality usable for registration, since no adequate image data has been acquired, the person to be identified is instructed or prompted to retry (step n24).

When a second image acquisition operation is subsequently performed by the person to be identified accordingly, images of the face of the person to be identified are acquired by the camera 13, and the CPU 22 extracts characteristic quantities of the face such as the eyes, nose and mouth to serve as characteristics in identifying the face based on the acquired face image data. Thereafter, the same processes as the processes at step n21 and later are performed according to the image quality (step n25).

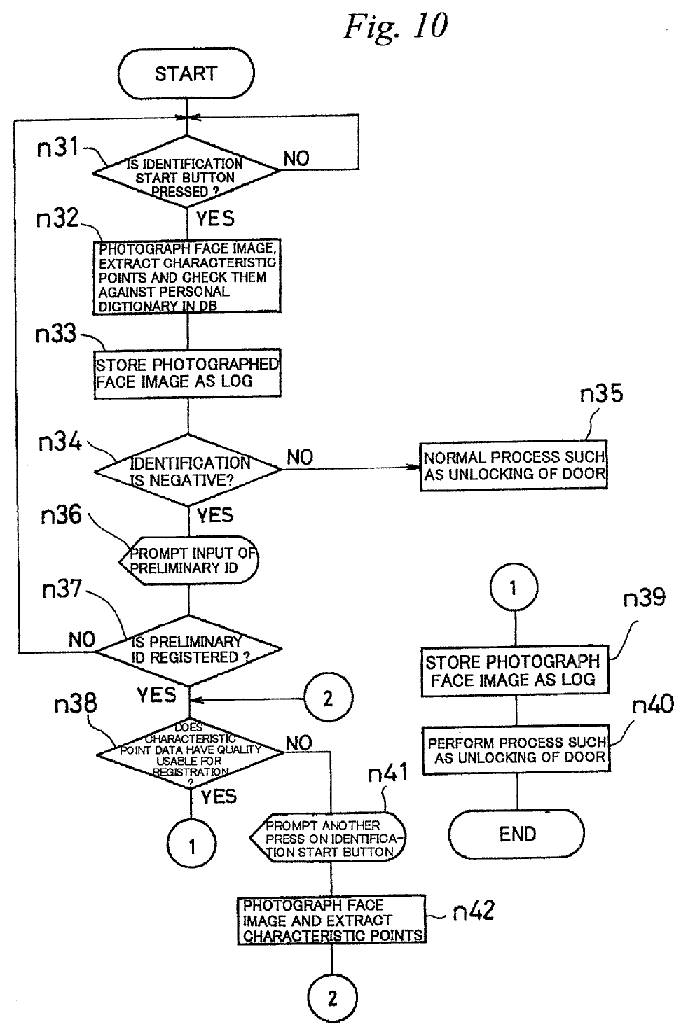

A description will now be made with reference to the flow chart in FIG. 10 on processes and operations using a preliminary ID during a preliminary operation of the face image identification apparatus 11. In this case, steps n31 to n35 and steps n38 to n42 in FIG. 10 will not be described in order to avoid repetition because they have the same contents of processing as those of steps n11 to n15 and steps n21 to n25 in FIG. 9 which have already been described, and a description will be made on steps n36 and n37 which are different.

The CPU 22 prompts a person to be identified having no real ID information or a person who has forgotten the real ID number to input preliminary ID information of the person. The identifying capacity is increased by providing the preliminary ID function (step n36).

When the person to be identified inputs preliminary ID information accordingly, the CPU 22 judges the validity of the preliminary ID information. If the information is regarded correct, it is associated with the real ID, and the person is authenticated as a right person. If no ID information is input or if the preliminary ID information is judged to be incorrect at this time, the acceptance is rejected, and the process stands by for the next identifying operation (step n37).

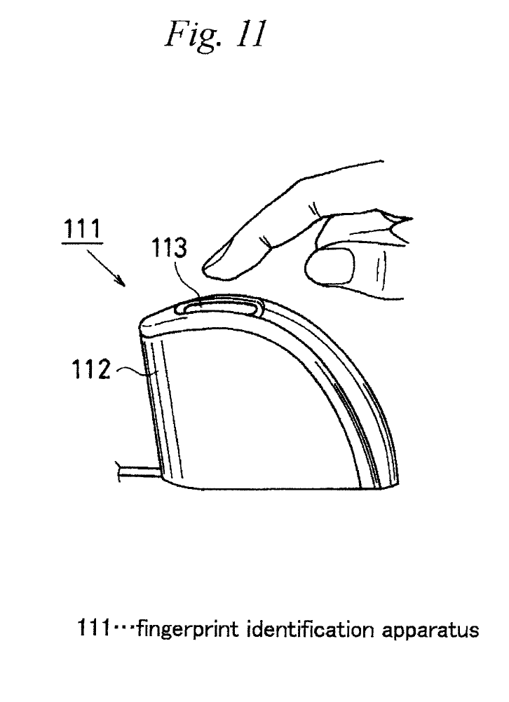

FIG. 11 shows a fingerprint identification apparatus 111 representing another embodiment of the invention. The fingerprint identification apparatus 111 has a fingerprint acquisition surface 113 on a top surface of an apparatus main body 112 to read the pattern of a fingerprint at the tip of a finger when the tip of the finger is put on the same. The use of such a fingerprint identification apparatus 111 also allows a person to be correctly identified and judged because characteristics identifying the person can be obtained in the same way as that of the face image identification apparatus 11.

When the fingerprint identification apparatus 111 is used, since it is difficult for a registration manager to check whether ID information matches a person from image data of a fingerprint, authentication is passed when a certain number of characteristic points required for identification are acquired from characteristic point data. Therefore, image data is not essential in the case of a fingerprint.

As described above, a preliminary operation period is provided in which identification information of people to be registered is registered in advance and in which biometrics information of a person to be identified is collected in association with the identification information each time the person to be identified performs a control operation such as unlocking of a door by prompting the person to input the identification information such as an ID from an input unit such as ten keys. An official personal dictionary can be created by associating the identification information and biometrics information of each person using the identification information as a key for identification after the preliminary operation period. This makes it possible to omit an operation of registering biometrics information in advance in which the registration manager must perform a separate registering operation in advance for all people to be registered. This makes it possible to save time and labor required for both of the people to be identified and the registration manager to perform the pre-registration and to generate personal registration data at natural attitudes and identification timing of the people to be registered that are encountered in daily use of such an apparatus, which ensures improvement of recognition performance at the time of identification.

Referring to the correspondence between the inventive configuration and the configuration of the above embodiments,

the personal identification apparatus of the invention corresponds to the face image identification apparatus 11 and the fingerprint identification apparatus 111 of the embodiments.

Similarly:

the input unit corresponds to the secret keys 18;

the acquisition unit corresponds to the camera 13 and the image acquisition section 31;

the storage unit corresponds to the registration file DB, the optimized candidate data file 36 and the registration data file 38;

the judging unit, generation unit and preliminary operation step correspond to the CPU 22 and the optimizing calculation section 37;

the first identification unit and the first identification step correspond to the optimized candidate data file 36; and

the second identification unit and the second identification step correspond to the registration data file 38. However, the invention may be practiced based on the technical ideas set forth in the appended claims and is not limited to the configuration of the above embodiments.

For example, although the configuration of the above embodiments is separated into the section for acquiring face image data and authentication data and the center apparatus 21 for authenticating the same, the invention is not limited to the same, and an integral configuration may be provided in which the data acquisition section has the identification and authentication functions in itself alone. Further, although a face image has been referred to as an example of biometrics information, a configuration may be employed in which a person to be identified is judged from fingerprint information or voice print information.

The invention makes it possible to omit an operation of registering biometrics information in advance in which the registration manager must perform a separate registering operation in advance for all people to be registered. It is therefore possible to save time and labor required for both of the people to be identified and the registration manager to perform the pre-registration and to generate personal registration data at natural attitudes and identification timing of the people to be registered that are encountered in daily use of such an apparatus, which ensures improvement of recognition performance at the time of identification.

Further, the invention makes it possible to construct an identification system with improved automatic registration having an efficient registration capability requiring less time and labor when used in various recognition apparatus and systems.

What is claimed is:

1. A personal identification apparatus for identifying a person from biometrics information, comprising:
an input unit for inputting identification information for identifying the person to be identified;
an acquisition unit for acquiring biometrics information of the person to be identified; and
a storage unit to which the identification information is input from the input unit and in which the identification information and the biometrics information is stored in association with each other when the biometrics information is acquired by the acquisition unit.

2. A personal identification apparatus for identifying a person from biometrics information, comprising:
an input unit for inputting identification information for identifying the person to be identified;
an acquisition unit for acquiring biometrics information of the person to be identified;
a judging unit for judging whether the acquired biometrics information has been registered or not; and
a storage unit which accepts input of the identification information from the input unit when the judging unit judges that the biometrics information has not been registered and in which the biometrics information acquired by the acquisition unit is stored in association with the identification information.

3. A personal identification apparatus according to claim 2, wherein the person is identified based on the identification information input from the input unit when the judging unit judges that the biometrics information has not been registered.

4. A personal identification apparatus for identifying a person from biometrics information, comprising:
a first identification unit for collecting biometrics information of the person to be identified at the time of identification of the person when the person is identified by inputting identification information;
a generation unit for generating personal data based on the biometrics information collected by the first identification unit; and
a second identification unit for identifying the person based on the biometrics information collected by the first identification unit and the personal data generated by the generation unit.

5. A personal identification apparatus for identifying a person from biometrics information, comprising:
a biometrics information collecting unit for collecting biometrics information of the person to be identified when identification information is input;
a generation unit for generating personal data based on the biometrics information collected by the biometrics information collecting unit; and
an identification unit for identifying the person based on the biometrics information collected by the biometrics information collecting unit and the personal data generated by the generation unit.

6. A personal identification system for identifying a person from biometrics information, comprising:
a center apparatus in communication and connection with personal identification apparatus having an input unit for inputting identification information and an acquisition unit for acquiring biometrics information of the person to be identified, the center apparatus having a storage unit to which the identification information is input from the input unit and in which the identification information and the biometrics information is stored in association with each other when the biometrics information is acquired by the acquisition unit.

7. A method of personal identification for identifying a person from biometrics information, comprising:
a biometrics information collecting step for inputting identification information and collecting biometrics information of the person;
a preliminary operation step for generating personal data that is tentatively registered and used based on the information collected at the biometrics information collecting step; and
an identification step for identifying then person based on the personal data generated at the preliminary operation step.

8. A method of personal identification for identifying a person from biometrics information, comprising:
a first identification step for identifying the person by inputting identification information and collecting biometrics information of the person;
a preliminary operation step for generating personal data that is tentatively registered and used based on the information collected at the first identification step; and
a second identification step for identifying the person based on the personal data generated at the preliminary operation step.
